(19) United States
(12) Patent Application Publication
(10) Pub. No.: US 2001/0033776 A1
(43) Pub. Date: Oct. 25, 2001

(54) Cutter plate and cutting tool for machining

(76) Inventor: Stefano Villa, Como (IT)

Correspondence Address: VENABLE, BAETJER, HOWARD & CIVILETTI, LLP, P.O. Box 34385, Washington, DC, 20043-9998, US

(21) Appl. No.: 09/837,181

(22) Filed: Apr. 19, 2001

(30) Foreign Application Priority Data
Apr. 19, 2000 (DE) 100 19 398.6

(51) Int. Cl. B23B 5/20; B26D 1/12

(52) U.S. Cl. 407/33; 407/40

(57) ABSTRACT

A cutter plate, in particular a spherical face milling cutter, is provided for a cutting tool, and is made of a hard metal and has four wings with cutting edges. The cutting body, which is cruciform in a view from the front, has cutting edges, which extend from the area of the circumference of the cutting tool as far as its axis of rotation, or at least close to it. A simple clamping device, for example a clamping claw, is sufficient for fastening the cutting body on the tool body. The cutting body provides a distribution of the forces acting on one or several wings to all wings, in particular during interrupted cutting, wherein not all the cutting edges of the cutting body are in simultaneous contact with the workpiece, so that a good force transfer to the tool body is possible.

The cutting body can be assembled from two individual cutter plates, which are plugged together.

The invention relates to a cutter plate, in particular a reversible cutter plate, as well as to a cutting tool with two cutter plates.

Rotating cutting tools with several cutter plates, wherein cutting edges extend from a circumferential area of the tool to the axis of rotation, are known. EP 0 683 002 B2 discloses such a cutting tool. It has a tool body with a spherical end area. Cutting edges have been formed in this spherical end area, and grooves for chips are provided between them. The cutting edges have been formed directly on the tool body. When the cutting edges become worn, the tool in its entirety must be replaced or, if possible, honed again.

Since this has been considered to be impractical in some cases, and moreover since there is great stress on the material at the cutting edges, cutter plates made of a hard metal or other hard materials are often employed in connection with cutting tools. These are fastened on the cutting tool.

A spherical face milling cutter is known for this purpose from EP 0 502 543, on whose tool body two cutter plates are fastened. The tool body has a hemispherically rounded end area, on which two plate seats are formed. Two cutter plates, each of which has an arc-like rounded cutting edge, are provided for fastening on these plate seats. The cutting edges extend from the circumferential area of the spherical face milling cutter approximately as far as the axis of rotation.

In contrast to the previously mentioned prior art, wherein a plurality of cutting edges are formed on the spherical cutter head, this cutting tool has only two cutting edges. However, in view of increasing the cutting output, a greater number of cutting edges is desirable To this end it is known from DE 39 22 463 to provide four plate seats in the appropriate end area of the tool body of a spherical face milling cutter. One cutter plate is held in each plate seat, wherein the cutter plates are individually clamped in place.

With this spherical face milling cutter, the cutting edges cannot be extended to the axis of rotation. Moreover, the plate seats become comparatively filigreed, at least in case of reduced diameters. A considerable weakening of the tool body as a whole results from the plate seats particularly in the area in which large forces occur—namely in the area of the plate seats.

Based on this, it is the object of the invention to provide an opportunity by means of which it is possible to construct a cutting tool with cutting edges of a hard material and also having a large number of cutting edges in the face area.

This object is attained by means of the cutting body in accordance with claim 1.

The cutting body of the invention is a body with tour wings, cruciform in a front view, which has four cutting edges. This provides the basis for cutting edge geometries wherein four cutting edges meet in the face area of the cutting tool. The tool body need not extend to the tool face. While in connection with the use of several cutter plates, each with their own plate seats, each cutter plate must separately transmit the occurring forces to the tool body, with the four-wing cutting body the forces occurring at one wing are mutually transmitted to the tool body by all wings. Here, a considerably more rigid seating of the cutting body on the tool body results—in comparison with solutions with separate cutter plates.

Moreover, servicing is considerably eased. By means of the positionally correct mounting of the cutting body on the tool body, all cutting edges are aligned in respect to each other with an accuracy inherent in the cutting body. In comparison with solutions with several cutter plates and several plate seats, it is possible by means of the attainment of the object in accordance with the invention, which provides only one hard metal cutting body and only one plate seat for the four cutter plates, to achieve greater accuracy.

It is also possible to design the cutter body in two parts.

In this case it consists, for example, of two plate-shaped elements, which are designed identical and can be plugged into each other. To this end, each one has a cutout, which is suitable to receive another cutter plate. By means of this, two cutter plates can be arranged spatially crossing each other and engaging each other. For one, this provides the chance to conduct the cutter plates as closely as possible to each other, and in this way to achieve a large number of cutting edges also in the front area of the cutting tool, as well as the prerequisite for a simple and secure seating of the cutter plates on a tool body. For example, it is possible to clamp a cutter plate directly by fastening means, while the other cutter plate is then maintained in place by the first mentioned cutter plate. In this way it becomes possible to secure both cutter plates in the plate seat is with a single clamping or fastening means.

The simple shape, free of undercuts, of the cutter plates permits their manufacture from a hard metal (sinter hard metal) or, if required, from some other hard material. Manufacture is provided, for example, by pressing and sintering of hard metal powder. In a preferred embodiment, the cutter plate is here designed in such a way that the cutout is shaped for receiving a further identical cutter plate. To this end the cutout of the cutter plate has two alignment faces, which are located opposite each other and extend along an insertion direction and constitute guide faces when the cutter plates are inserted into each other. In their shape, the alignment or guide faces here match the corresponding associated flanks of the other, identical cutter plate to be inserted into the cutout. For example, the faces are designed to be level; but it is also possible for ribs or other protrusions, which fit into corresponding cutouts at the groove flanks, to be formed on the plate flanks. The identical cutter plates are aligned in relation to each other by the guide or alignment faces resting against the respective flanks of the other cutter plate.

For axial alignment. i.e. fixing the relative position of the cutter plates in relation to each other in the inserting direction, preferably one alignment face is provided on each cutter face and extends transversely in respect to the insertion direction This alignment face forms a stop, so to speak, when pushing the cutter plates into the respective cutout of the respectively other cutter plate.

In this connection it is preferred to place each of the alignment faces used as stop faces in the center of the cutter plate, so that the cutter plates, when plugged into each other, do not have an axial offset. With preferred applications, the insertion direction agrees with the axis of rotation of a rotating tool, so that the outer contours, or the cutting edges, of the cutter plate are located on a common plane when the cutting tool turns around its axis of rotation.

Preferably the cutter plate is embodied to be symmetrical in respect to a first line of symmetry, which is oriented transversely to the insertion direction, and therefore also transversely in respect to the insertion slit (i.e. also to the cutout). By means of this it is possible to achieve that, when two identical cutter plates are plugged into each other, they form a cutting body which can be employed in two installed positions in a tool body. The first installed position uses cutting edges of the first cutter plate which are adjoining the cutout, and cutting edges of the second cutter plate, which faces away from the cutout. In the second installed position the conditions are reversed, i.e. the bodies put together from the two cutter plates plugged together can be turned by 180°.

In addition, the cutter plate is preferably symmetrically aligned in respect to a second line of symmetry which, the same as the first line of symmetry, extends through the cutter plate center and coincides with the insertion direction. By means of this it becomes possible to provide two active cutting edges on each cutter plate, so that again a total of four cutting edges are obtained, which extend from the circumferential area of the cutting tool as far as its axis of rotation, or at least close to the latter. The number of cutting edges z=4 results. The cutter (cutting edges) preferably extend without interruption from the exterior circumference to, or close to, the axis of rotation.

Manufacture of the cutting body (one- or two-piece) can take place, for example, by means of a metal injection molding process, wherein hard metal powder, which was plasticized by adding small amounts of plastic, is preformed by means of an injection molding process, and the molded blank obtained in this way is baked or sintered.

With such a one-piece cutting body, the cutting forces acting on one wing, or one cutting edge, are distributed to all wings and are therefore evenly transmitted into the tool body. This allows in particular the fastening of the cutting body by means of a clamping claw which does not clamp all wings of the cutting body in place. In a preferred embodiment, the flanks (front and back) of each wing are preferably constituted by plane faces. This makes powder-metallurgical production, as well as clamping in the tool body, easier.

An appropriate cutting tool with these cutter plates requires only a simply designed plate seat. The latter is embodied in such a way that at least one of the cutter plates, once they are plugged together, or two wings of the cutting body, can be clamped in place on the plate seat.

With the two-piece design it suffices if the tool body has a single clamping claw, which is assigned to the cutter plate whose cutout points away from the tip of the cutting tool. The second cutter plate, whose stop face is held in the axial direction on the corresponding alignment and stop face of the clamped cutter plate, can he secured by clamping this cutter plate. It is interlocking held in this way, while the other cutter plate can be held in frictional connection away from the tool body, and interlockingly in the direction toward the tool body. However, other fastenings can also be provided for the cutter plate in place of the frictional clamping. A considerable advantage of clamping the cutting body of the two plugged together by means of a single clamping jaw lies in the simplicity of the plate seat and in simple manipulation. A single fastening screw suffices, and the plate seat can be embodied to be very rigid.

Similar conditions apply for the one-piece cutting body. The clamping claw can be an element separate from the tool body, or can be embodied in one piece with it. This has the advantage that the clamping claw provides an improvement of the transfer of torque.

The cutting tool in accordance with the invention is particularly suited as a finishing tool. In this case the possible different clamping of the individual cutter plates of wings of the cutting body is harmless. But the interruption-free embodiment of the cutting edges has a positive effect. It is also advantageous if the wings are arranged at uniform angular spacings of, for example, 120° or 90°. This result in a even operation of the tool. The one-piece tool body preferably has wings oriented in the axial direction. An axial cutting angle of the cutting edges can also be achieved by arranging the latter inclined in respect to the wings. If required, the wings of the one-piece tool body can also have an axial angle (and, if required, also a radial angle).

Details of advantageous embodiments of the invention are subject of the dependent claims and ensue from the drawings, as well as the associated description. An exemplary embodiment of the invention is represented in the drawings. Shown are in:

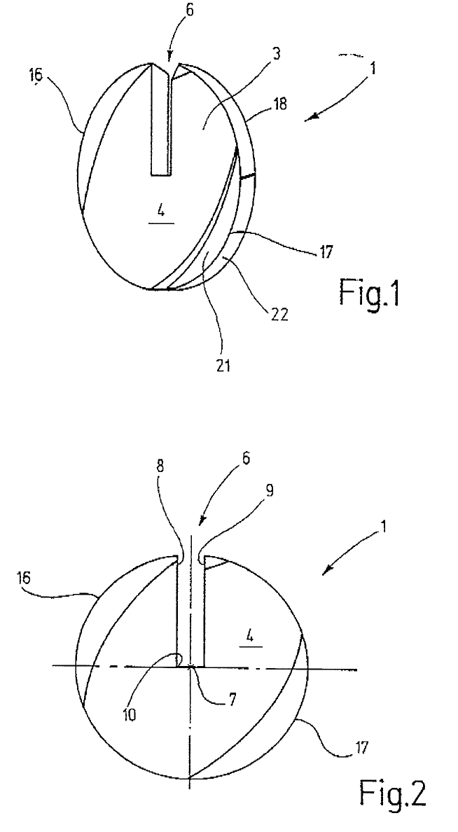

FIG. 1, a cutter plate in accordance with the invention in a perspective and simplified representation,

FIG. 2, the cutter plate in accordance with FIG. 1 in a lateral view,

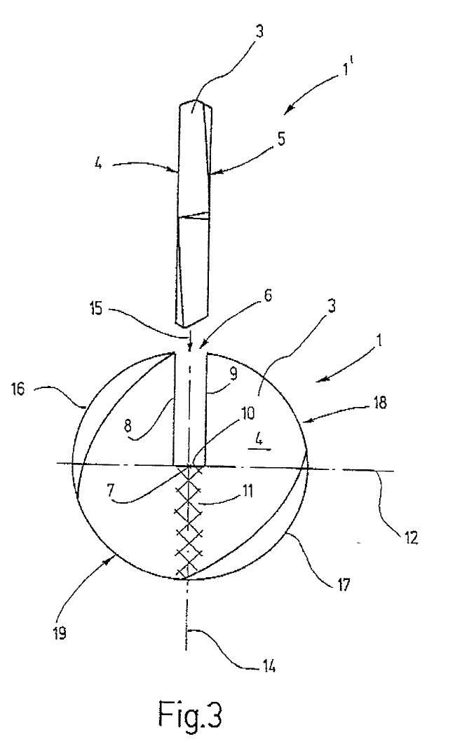

FIG. 3, two identical cutter plates in accordance with FIG. 1 or 2, rotated by 90° in respect to each other, in the state where they are not plugged together,

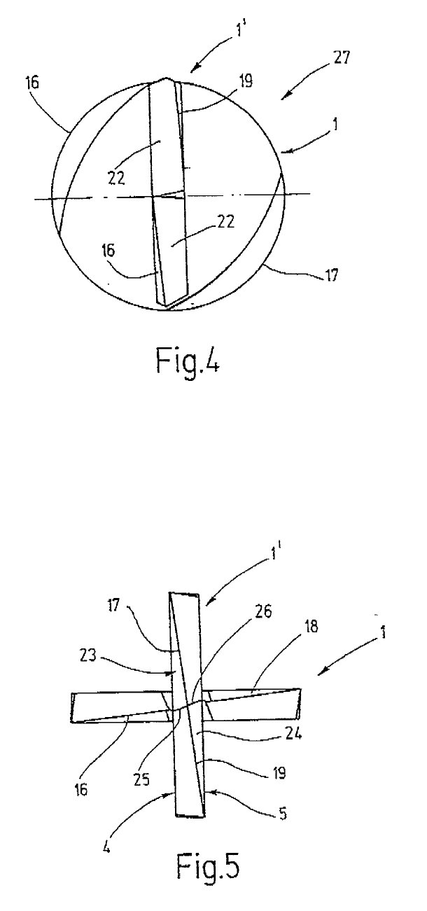

FIG. 4, the cutter plates in accordance with FIG. 3 in the plugged-together state in a lateral view,

FIG. 5, the cutter plates in accordance with FIG. 4 in a plan view, viewed in the direction of the axis of rotation,

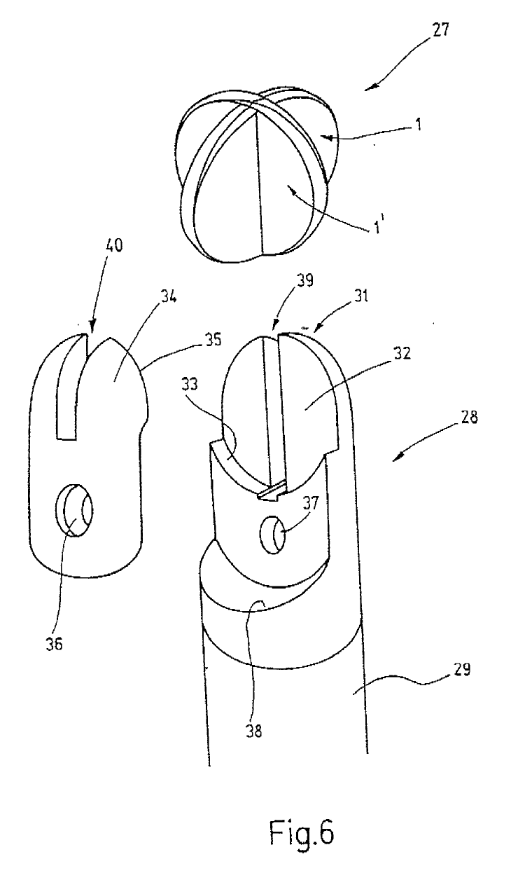

FIG. 6, a cutting body in accordance with FIG. 5, put together from two cutter plates, and an associated tool body, in a perspective exploded view,

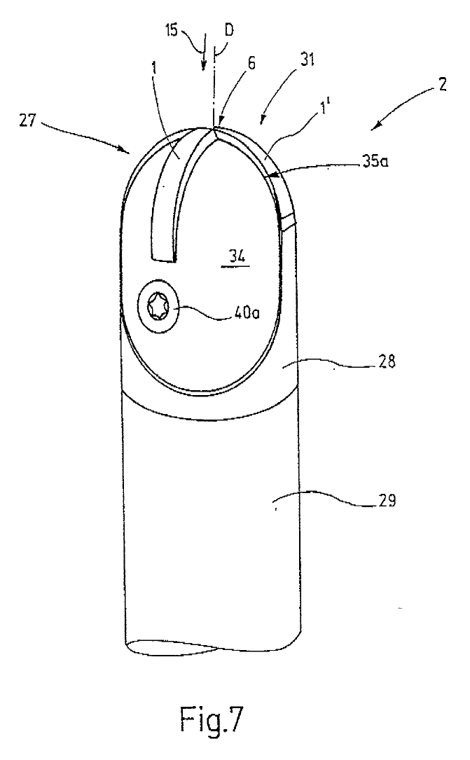

FIG. 7, a cutting tool with two cutter plates in accordance with FIGS. 1 to 5,

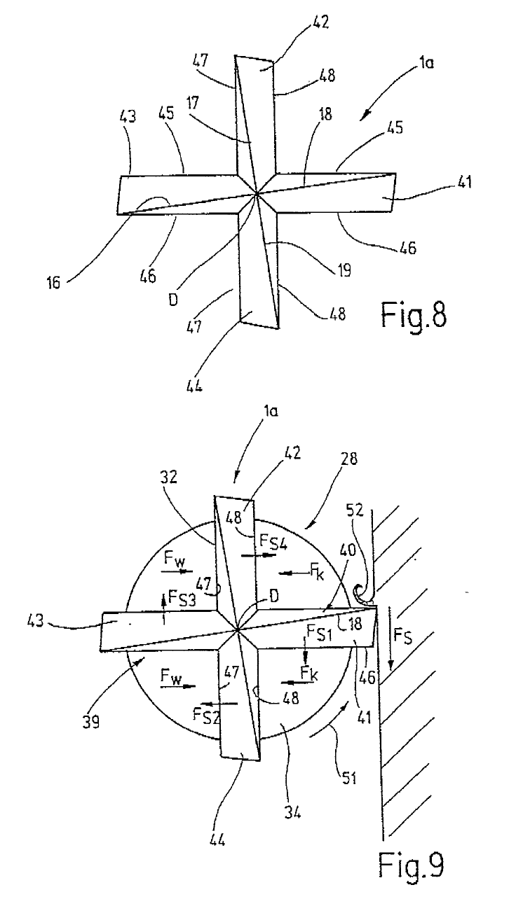

FIG. 8, a cutting body 1a, designed in one piece, in a plan view, viewed in the direction of its axis of rotation, and

FIG. 9, a cutting tool equipped with the cutting body in accordance with FIG. 8 during a cutting operation.

A cutter plate 1, which is used for equipping a cutting tool, such as a spherical face milling cutter 2 in accordance with FIG. 7, is represented in FIG. 1. The cutter plate 1 has a base body 3, which is embodied approximately disk-shaped. It is bordered by two flat sides 4, 5, located opposite each other, such as can be seen at the top of FIG. 3, for example. The flat sides are oriented parallel in respect to each other and have approximately circular boundaries. However, a different boundary is also possible with desired different geometries.

A slit-shaped cutout 6 is provided in the base body 3, which forms a receiving slit for another cutter plate. The cutout 6 is open toward three sides and extends from the edge of the cutter plate 1 as far as its cutter plate center 7, as shown in FIG. 2 in particular. Here, the cutout 6 is bordered by two alignment faces 8, 9, which are parallel and spaced apart from each other, and by a further alignment surface 10, which is directed at right angles in respect to the alignment faces 8, 9 and extends through the cutter face center 7. Following the alignment face 10, which constitutes a detent and stop face for a respectively other cutter plate 1′ to be inserted (FIG. 3), support face areas 11 extend over the respective flat sides 4, 5 of the cutter plate 1. The thickness of the base body 3 matches the width of the cutout 6. In other words, the distance of the two support faces of the flat sides 4, 5 between each other matches the distance of the alignment faces 8, 9 between each other. In this case the measurements have been fixed in such a way that the base body 3 of the cutter plate 1′ can be inserted into the slit 6 of the cutter plate 1 without jamming, but nevertheless is seated free of play in it. The same applies to the opposite.

The cutter plate 1 is designed to be doubly symmetrical. A first symmetry line 12 extends through the cutter plate center 7 and parallel with the alignment face 10, i.e. transversely in respect to the slit 6. A second symmetry line 14 also extends through the cutter plate center 7, but parallel with the slit 6, i.e. with its alignment faces 8, 9, and therefore parallel with the plate insertion direction indicated by an arrow 15 in FIG. 3.

A total of four continuous cutting edges 16, 17, 18, 19 are formed on the edge of the cutter plate 1 (z=4). Here, the cutting edges 16, 17 are part of the flat side 4, and the cutting edges 18, 19 are part of the flat side 5. As follows from FIGS. 1 and 5, the cutting edges 16, 18 directly adjoin the slit 6. But the cutting edges 17, 19 are arranged on the side of the cutter plate 1, or 1′, facing away from the slit, so that here the course of the cutting edges is not interrupted by the slit 6. The cutting edges are each embodied between a chip face 21 and a free face 22. For example, the chip face 21 and the free face 22 are arranged and aligned on the cutter plate in such a way, that a positive cutting geometry, i.e. a positive cutting angle and a positive relief angle result when the cutter plates 1 are maintained without axial and radial cutting angles in a tool body. If required, it is also possible to work with a negative cutting angle, or with a completely negative cutting edge geometry (also a negative axial cutting angle). The cutting edges 16 to 19 each extend at least along a quarter of the circumference of the base body 3. As shown in FIG. 3, the cutting edges 16, 17 of the flat side 4, and correspondingly the cutting edges 18, 19 of the flat side 5, are arranged diagonally opposite each other. By means of the linear symmetry in respect to the first symmetry line 12, the cutting edge 16 extends symmetrically in respect to the cutting edge 19, concealed in FIG. 3, and the cutting edge 17 extends symmetrically in respect to the cutting edge 18. The cutting edges 16 and 18, as well as 17 and 19, are line-symmetrical in respect to the second symmetry line 14.

As can be seen in FIG. 4 in particular, the cutter plates 1, 1′ can be plugged into each other by means of their cutouts 6 in such a way that a compact cutting body with cutter plates 1, 1′ results, which are interlockingly aligned with each other. The alignment faces 10 of the two cutter plates 1, 1′ here rest on each other in the assembled state. The cutting edges 16 to 19 of the two cutter plates 1, 1′ lie on the same imaginary rotating body, for example a sphere. The cutting edges 16, 17, 18, 19 are offset by 90° in respect to the second symmetry axis 14. However, by means of an appropriate tilting and embodiment of the stop faces 8, 9 it is also possible to set different divisions.

As seen in FIG. 5, the cutting edges 17, 19 make a transition into each other without shoulders and interruptions, wherein they are located in a common plane. The common plane extends through the second symmetry line 14 and intersects the edge of the base body approximately at the height of the first symmetry line 12. The symmetry line 14, which is identical with the axis of rotation of the respective cutting tool (drilling or machining tool), intersects the cutting edges 17, 19, which transition into each other, at a point at which a respective J cutout 23, 24 for fixing the cutting edges 17, 19 in place ends in an obtuse-angled edge 25, 26. Thus, the obtuse-angled edges 25, 26 extend from the axis of rotation, or the second symmetry line 14, to the flat sides 4, 5, where the cutting edges 16, 18 of the respectively other cutter plate 1, 1′ join.

Such a cutting body 27 is provided for being received in a tool body 28 represented in FIG. 6. The tool body 28 has an essentially cylindrical shaft 29, which is flattened on one side in its end area and is spherically arched. On its free end, the tool body 28 has a plate seat 31, with which a plane face 32 is associated. On the shaft side, the plane face 32 makes a transition into a lateral contact face 33, which is curved in an arc shape and which is used as an axial support face for the cutting body 27. A clamping claw 34, which has a clamping face 35 for clamping the cutter plate 1′ in place and is located opposite the plane face 32 in the assembled state, is associated with the plate seat 31. The clamping claw is provided with a fastening opening 36, to which a threaded bore 37 is assigned, which is arranged in the tool body 29 adjacent to the lateral contact face 33. Next to the threaded bore, a support face 38 is formed on the tool body 28, on which the clamping claw 34 is supported when a fastening screw is tightened. A receiving gap 39, 40, which passes through the plate seat 31 at right angles in respect to the plane face 32, is provided transversely in respect to a clamping gap 35a formed between the clamping face 35 and the plane face 32. The receiving gap 39, 40 is used for the interconnected seating of the cutter plate 1 and therefore has a gap width which matches the thickness of the base body 3. Alternatively to the embodiment represented, the clamping claw can also be embodied in one piece with the tool body 28. An elastic connection in the area of the support face 38 can be used for this.

The completely assembled cutting tool 2 is represented separately in FIG. 7. As can be seen, the cutter plate 1′ is clamped on, or in the plate seat 31 by means of the clamping claw 34, The cutter plate 1′ is interlockingly connected with the cutter plate 1. The cutouts 6 of the cutter plates 1, 1′ mesh with each other and constitute the four-wing cutting body 27. The orientation of the cutter plate 1′ takes place in the axial direction by its resting against the lateral contact face 33. The cutter plate 1′ is additionally oriented in a first radial direction perpendicularly in respect to the plane face 32 because of being clamped against the plane face 32. Alignment in the radial direction at right-angles thereto, i.e. parallel in respect to the plane face 32, is provided by the cutter plate 1, which is fixed in place in the receiving gap 39 in this direction, which is parallel to the plane face 32.

However, in relation to the first radial direction, i.e. at right angles in respect to the plane face 32, the cutter plate 1 is held by the cutter plate 1′. The cutter plate 1′ is clamped in the axial direction by means of the clamping claw 34 and a fastening screw 40a, while the cutter plate 1 is interlockingly maintained in one axial direction by the cutter plate 1′, and in the opposite direction (toward the clamping shaft shaft) by means of an axial contact in the plate seat. Thus, a mixed frictional and interlocking seating of the cutting body 27, or of its cutter plates 1, 1′ is created. This makes possible a precise and secure seating of the cutting body 27, which is put together from two cutter plates 1, 1′, which hold each other in an interconnected manner. The plate seat is designed simple and uncomplicated, wherein the tool body 28 is only little weakened here and can therefore have great rigidity. Changing the cutter plates is particularly simple—it is sufficient to release the clamping claw 34 for being able to remove and replace the cutting body 27. The cutting body can moreover be turned in order to continue work with its cutting edges, which up to now were hidden in the plate seat.

Alternatively to the frictionally connected clamping, the cutter plate 1′ can also be held interlockingly. To this end it is possible, for example, to provide depressions in the cutter plate 1′, to which corresponding protrusions of the plate seat 31 and/or the clamping claw 34 are assigned. This also applies to the embodiment in accordance with FIG. 8 to be described later.

The four-wing cutting body is put together from two single plate-shaped cutter plates 1, 1′, which have appropriate cutouts for this, by means of which they are plugged together. If required, the cutting body 27 can be disassembled, for example for changing individual cutter plates, by pulling the cutter plates 1, 1′ apart. This therefore results in a cutting tool with four cutting edges which only has two identically embodied plate-shaped cutter plates 1, which are maintained on the tool body 28 by means of a single clamping screw 31.

A cutting body 1a is represented in FIG. 8, which on the outside can be essentially constituted the same as the cutting body 27 put together from cutter plates 1, 1′ and represented in FIG. 6, but which is embodied in one piece. The cutting body 1a has four wings 41, 42, 43, 44, which extend radially away from an axis of rotation D. The axis of rotation D is a symmetry line of the cutting body 1a. The approximately plate-shaped wings 41, 42, 43, 44 are aligned in pairs with each other (41-43, 42-44) They each have two flat sides 45, 46, or 47, 48, which are parallel in respect to each other and can be used as contact or clamping faces for seating the cutting body 1a in the work body 28. In the present case, the cutting body 1a has four cutting edges 16, 17, 18, 19, each of which extends from a place on the circumference, where the cutting body 1a has its greatest circumference, as far as the axis of rotation D. If required, the cutting body 1a can be designed to be reversible, wherein it corresponds in a lateral view approximately to the cutting body 27 represented in FIG. 4 and formed by two cutter plates 1, 1′, which are plugged into each other. In this case it constitutes a reversible cutting body. This has advantages because of the dual usability—but is not strictly necessary.

The cutting body 21 can be produced sinter-metallurgically from a hard metal powder, wherein initially a green compact is pressed and is subsequently sintered. However, it is much more advantageous to produce the cutting body 1a by means of a metal injection molding process. To this end hard metal powder, for example, which has been provided with small additions of plastic, can be pressed in a mold by means of an injection molding method, whereatter the blank created in this manner is sintered. The rigid cutting body 1a of four or more wings is created, which can be clamped by a single one of its wings. This is represented by way of example in FIG. 9. There, the cutting body 1a is clamped in the tool body 28 in accordance with FIG. 6. The clamping claw 34 clamps the flat flanks of faces 47, 48 of the cutting body 1a against the other flat contact face 32 with a clamping force Fₖ, which corresponds to a corresponding force F_{w}. at the abutment constituted by the contact face 32. In this way the wings 42, 44 of the cutting body 1a are solidly clamped by means of the clamping faces 47, 48. However, the wings 43, 45 are received by the receiving gaps 39, 40 essentially free of force. No clamping forces are present here. Centering of the axis of rotation D is caused in the end by the contact face 32 of the plate seat and the receiving gap 39 extending through the plate seat. Bevels, curves or cutouts can be provided in the transition area between the receiving gaps 39, 40 and the contact faces 32, 35 in order to relieve hollows between the wings 41, 42, 43, 44. Such hollows in the respective corner areas between the wings of the cutting body improve its stability. The force transfer can be further improved, if all four wings are clamped in place.

In actual operation, the tool rotates around the axis of rotation D, as represented by an arrow 51 in FIG. 9. Because of this, a cutting force Fs, which is to be transmitted from the cutting body 1a to the tool body 28, is generated at the respectively active cutting edge (here cutting edge 18) when cutting oft a chip 52. Here, the transmission of the drive torque takes place to all wings 41, 42, 43, 44 of the cutting body 1a. Thus, the cutting force FS is distributed more or less evenly to all four wings 41 to 44 as partial cutting force Fₛ₁, Fₛ₂, Fₛ₃, Fₛ₄. The transmission of force here occurs by means of a bending strain on the wings in the vicinity of the axis of rotation D. However, the cutting body 1a has its greatest axial length and its greatest cross section in this area, so that the cutting body 1a, even if it is made of relatively brittle material, here has sufficient strength. Because of the distribution of the force generated on one cutting edge to all four wings and thus of the force introduction into the tool body over a large surface, a great precision of the cutting edge positioning and large rigidity of the seating of the cutting body is achieved, in particular during intermittent cutting (machining). A cutter plate, in particular a spherical face milling cutter, is provided for a cutting tool, and is made of a hard metal and has four wings with cutting edges. The cutting body, which is cruciform in a view from the front, has cutting edges, which extend from the area of the circumference of the cutting tool as far as its axis of rotation, or at least close to it. A simple clamping device, for example a clamping claw, is sufficient for fastening the cutting body on the tool body. The cutting body provides a distribution of the forces acting on one or several wings to all wings, in particular during interrupted cutting, wherein not all the cutting edges of the cutting body are in simultaneous contact with the workpiece, so that a good force transfer to the tool body is possible.

The cutting body can be assembled from two individual cutter plates, which are plugged together.

1. A cutting body for a rotating cutting tool, in particular a machining tool, in particular a spherical face milling cutter,
having four plate-shaped wings (41, 42, 43, 44) extending away from an axis of rotation (D), each of which has at least one cutting edge (16, 17, 18, 19) formed between a free face (22) and a chip face (21), wherein the cutting edges (16, 17, 18, 19) define a common rotating body, which is concentric to the axis of rotation (D), and wherein the cutting body (1) is made of hard metal.

2. The cutting body in accordance with claim 1, characterized in that the wings (41, 42, 43, 44) of the cutting body (1a) are arranged at uniform angular distances from each other.

3. The cutting body in accordance with claim l, characterized in that the clamping faces (45, 46, 47, 48) provided at the wings (41, 42, 43, 44) of the cutting body (1a) are embodied to be flat.

4. The cutting body in accordance with claim 1, characterized in that the cutting body (1a) is embodied to be linearly symmetrical in respect to the axis of rotation (D).

5. The cutting body in accordance with claim 1, characterized in that it is formed by two cutter plates (1, 1′), each of which has a slit-shaved cutout (6) for receiving the respectively other cutter plate (1′).

6. The cutting body in accordance with claim 5, characterized in that the cutout (6) of the cutter plate (1) has three open sides, which define an insertion direction (15) for a further cutter plate (1′), and which is equipped for receiving at least one identical cutter plate (1′) as the further cutter plate (1′).

7. The cutting body in accordance with claim 5, characterized in that the cutout (6) has at least one alignment face (10), which is assigned to an identical alignment face of the cutter plate (1′), which is to be received in the cutout (6).

8. The cutting body in accordance with claim 7, characterized in that the cutout (6) is bordered by several alignment faces (8, 9, 10).

9. The cutting body in accordance with claim 7 or 8, characterized in that the alignment faces (8, 9, 10) are plane faces.

10. The cutting body in accordance with claim 5, characterized in that the cutout (6) is an elongated slit, which extends from the edge of the cutter plate (1) in the direction toward it oppositely located side.

11. The cutting body in accordance with claim 10, characterized in that the slit extends as far as the center (7) of the cutter plate (1).

12. The cutting body in accordance with claim 7 and 11, characterized in that the alignment face (10) is an end face, which closes off the slit at the cutter plate center (7).

13. The cutting body in accordance with claim 7, characterized in that two alignment faces (8, 9) of the alignment faces (8, 9, 10) are aligned parallel with each other at each cutter plate (1, 1′).

14. The cutting body in accordance with claim 5, characterized in that the cutter plate (1) has a base plate (3), which is embodied to be symmetrical with the opening of the cutout (6) in respect to a first symmetry line (12), which is aligned transversely in respect to the insertion opening (15).

15. The cutting body in accordance with claim 5, characterized in that the cutter plate (1) has a base plate (3), which is embodied to be linearly symmetrical in respect to a second symmetry line (14), which extends through the cutter plate center (7) and coincides with the insertion direction (15).

16. The cutting body in accordance with claim 14 and 15, characterized in that it has a disk-shaped base body (3) with two flat sides (4, 5), which are parallel to each other, wherein the cutout (6) of the cutter plate (1) is designed in such a way that two identical cutter plates (1, 1′) can be put together at an angular offset of 180° around the first symmetry line (12) and a different angular offset around the second symmetry line (14), so that they receive each other in their cutouts (6).

17. The cutting body in accordance with claim 5, characterized in that in the put-together state the cutter plates (1, 1′) are located at each point of their outer contours on a common curved path when rotated around the second symmetry axis (14).

18. The cutting body in accordance with claim 16, characterized in that the cutter plates (1, 1′) are embodied in such a way that in the put-together state they are held interlockingly against each other and rest interlockingly against each other in the insertion direction (15).

19. The cutting body in accordance with claim 5, characterized in that each cutter plate (1, 1′) has respectively four cutting edges (16, 17, 18, 19).

20. A cutting tool with two cutter plates (1, 1′), or one cutting body (1a), in accordance with claims 1 to 4, wherein the cutter plates (1, 1′) receive each other in their cutouts (6).

21. The cutting tool is accordance with claim 20, characterized in that it has a tool body (28) with a plate seat (31), to which a clamping claw (34) is assigned, which is embodied separately or also in one piece with the remaining tool body.

22. The cutting tool is accordance with claim 20, characterized in that the plate seat (31) with the clamping claw (34) defines a clamping gap (35a) for one of the cutter plates (1′) or at least one wing (42) of the cutting body (1a), and that a receiving gap (39, 40) is embodied transversely in respect to the clamping gap (35a), which intersects the plate seat (31) and the clamping claw (34) and which is embodied for receiving the other cutter plate (1) or other wing (43) of the cutting body (1a).

23. The cutting tool is accordance with claim 22, characterized in that the cutter plate (1) received by the receiving gap (39, 40) is interlockingly maintained in the axial direction (15) of the cutting tool (2) by the cutter plate (1) which is held, preferably frictionally connected, in the clamping gap (35a), and by the plate seat.
